(19) United States
(12) Patent Application Publication
(10) Pub. No.: US 2009/0050174 A1
(43) Pub. Date: Feb. 26, 2009

(54) CART AND BASKET WASHER AND METHOD

(76) Inventor: Mycheal A. Gheparde, Everett, WA (US)

Correspondence Address: GRAYBEAL JACKSON LLP, 155 - 108TH AVENUE NE, SUITE 350, BELLEVUE, WA, 98004-5973, US

(21) Appl. No.: 12/195,314

(22) Filed: Aug. 20, 2008

Related U.S. Application Data
(60) Provisional application No. 60/965,554, filed on Aug. 20, 2007.

(51) Int. Cl. B08B 7/00; B08B 13/00

(52) U.S. Cl. 134/1; 134/18; 134/56 R; 134/57 R; 134/123

(57) ABSTRACT

According to embodiments, a cart or shopping basket washer is configured to wash one or more carts or shopping baskets. The cart or shopping basket washer may include self-propelled apparatuses to treat a substantially stationary cart or shopping basket, or may include a conveying mechanism to propel a cart or shopping basket through one or more substantially stationary washing stations. The cart or shopping basket washer may include provisions from accepting commands from non-trained persons, for receiving payment, and for receiving indication of a loyalty relationship. The cart or shopping basket washer may include sensors and logic to ensure the safety of people and property.

### CROSS REFERENCE TO RELATED APPLICATIONS

This patent application claims priority benefit from and, to the extent it is not inconsistent with this application, incorporates by reference U.S. Provisional Patent Application Ser. No. 60/965,554, entitled SHOPPING CART WASHER AND DRYER, invented by Mycheal A. Gheparde, filed Aug. 20, 2007.

### BACKGROUND

Hand-pushed carts are used in many environments, and especially in retail environments for conveniently carrying items selected for purchase. Other environments where carts are used include airports, where such devices may be used to carry baggage. For carrying fewer items, baskets such as shopping baskets may be used.

Both consumers and establishments offering carts have heretofore needed to deal with soil, germs, and water left on carts from previous users or from the environment.

### OVERVIEW

According to illustrative embodiments, a facility is provided for cleaning, sanitizing, and/or drying (treating) hand-pushed carts, such as shopping carts or baskets, such as shopping baskets. According to embodiments, such a facility may be provided for use by trained employees. According to other embodiments, such a facility may be provided for use by untrained personnel such as consumers. According to an embodiment, a shopping cart or basket washer may be provided on a pay-per-use basis, such as coin-operated, paper money operated, token-operated, credit or debit card operated, loyalty card operated, etc. According to an embodiment, the user may select one or more of a subset of all available treatment options. According to an embodiment, one or more treatment options may be priced individually or as a group, including, for example, a base treatment that is free or included as part of a loyalty card program.

According to an embodiment, a facility for treating hand-pushed carts may be provided to substantially simultaneously process a plurality or group of nested carts. According to another embodiment, a facility may be provided to treat a cart singly.

According to an embodiment, a track may propel one or more carts, including nested carts, through a series of treatment stations. According to another embodiment, one or more moving arms having treatment apparatuses disposed thereon may be propelled around one or more stationary carts.

According to an embodiment one or more sensors may be used to determine the state of a cart and an electronic controller may responsively determine an appropriate treatment or set of treatments. According to an embodiment, one or more sensors may be used to determine the position, shape, and/or size of a cart and an electronic controller may responsively adjust operation of the facility. According to an embodiment, one or more sensors may determine a safety state and an electronic controller may responsively permit or disable operation of the facility.

According to an embodiment, one or more baskets may be cleaned by moving the one or more baskets past one or more nozzles or moving the nozzles past one or more baskets. The nozzles may apply one or more of a water rinse, wash water, pressurized water, steam, and/or antibacterial solution. The basket washer may include one or more of safety sensors, a control panel, and payment processing coupled to an electronic controller. The baskets may optionally be dried using various methods such as pressurized air, vacuum, shaking, and ultrasonic vibration. The basket washer may be integrated into a cart washer.

### BRIEF DESCRIPTION OF THE DRAWINGS

FIG. 1 is a diagram of a cart or basket washer, according to an embodiment.

FIG. 2 is a diagram of an illustrative control panel according to an embodiment.

FIG. 3 is a depiction of a washer that includes provision for washing a shopping cart in a first volume and a shopping basket in a second volume, according to an embodiment.

FIG. 4 is a depiction of a shopping basket washer, according to an embodiment.

FIG. 5 is a flow chart illustrating a method for washing a cart or basket, according to an embodiment.

FIG. 6 is a block diagram of a cart or basket washer, according to an embodiment.

FIG. 7 is a block diagram of a series of treatments that may be applied to one or more baskets or carts, according to an embodiment.

### DETAILED DESCRIPTION

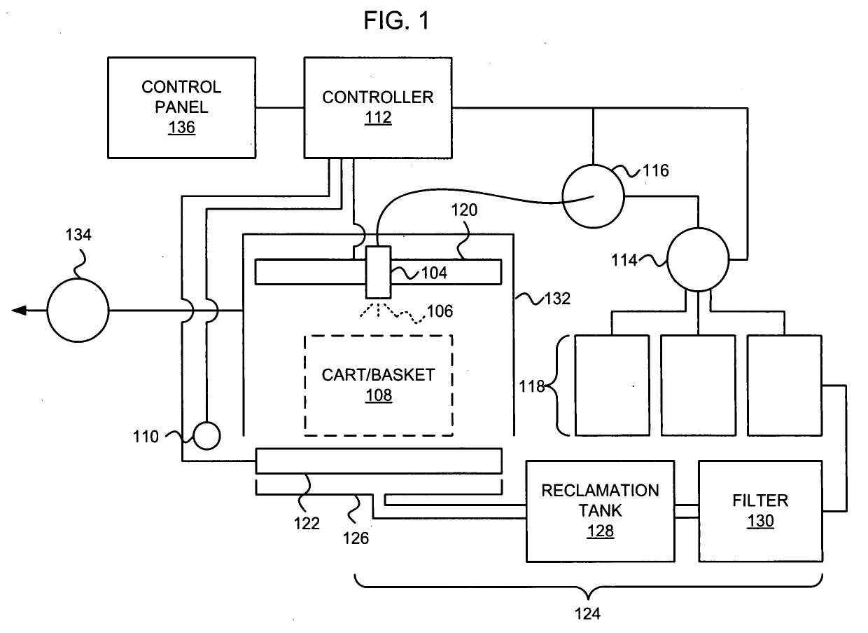

FIG. 1 is a block diagram of a cart or basket washer 102, according to an embodiment. According to an illustrative embodiment, the cart or basket washer 102 may be used to wash and optionally dry a cart or basket that is conveyed past washing stations. According to another embodiment, the cart or basket washer 102 may include a robotic arm that contains washing and drying components and is configured to translate and/or rotate around one or more carts or baskets disposed in a washing zone. According to an embodiment, the cart or basket washer 102 may include one or more fixed washing and drying stations and a conveyer or tracked system operable to propel or present the cart or basket to the stations.

Optionally, the cart or basket washer may include a variable speed or variable time control (not shown). For example a variable speed control may vary translation speed of a cart or basket conveyer or robotic arm translation. Alternatively, the variable speed or variable time control may abbreviate or skip wash steps. The variable speed or variable time control may be invoked by authorized personnel. Alternatively, in some embodiments, the variable speed or variable time control may be activated by a non-trained user according to his or her perceived need for speed or cleanliness.

According to an embodiment, each component may stand-alone, allowing the components to be spread out over a relatively large area. Alternatively, the components may be compressed to fit into a relatively small unit. The cart or basket washer may operate off of solar power, battery power, or wall outlet.

The cart washer 102 includes at least one nozzle 104 configured to provide a spray 106 at least one cleaning fluid to wash at least one cart 108 substantially without intervention of a user. At least one sensor 110 may be configured to sense a condition corresponding to safety of the user. A controller 112 operatively coupled to the at least one nozzle 104 and the at least one sensor 110 may be configured to determine the condition corresponding to safety of the user and conditionally actuate the nozzle. The nozzle 104 may be actuated to provide a spray 106 of a selected fluid through a selector valve 114 and a pump 116 to provide the selected fluid to the nozzle 104. The selector valve 114 may draw a fluid from one or more of a plurality of fluid tanks or sources 118.

The controller 112 may actuate a nozzle movement mechanism 120 and/or a cart or basket movement mechanism 122 to provide relative movement between the spray 106 and the cart or basket 108 when the safety condition is met. For example, the cart or basket washer 102 may include a cart or basket conveyer 122 configured to move the at least one cart or basket 108 past one or more stationary nozzles 104 when actuated by the controller 112. Alternatively, the nozzle 104 may be disposed on a moveable platform such as an arm or conveyer 120 configured to move the at least one nozzle 104 past the cart or basket 108. The controller 112 may thus conditionally drive the movement of the at least one nozzle 104 past at least one cart or basket 108.

The nozzle movement mechanism may include a moving arm 120 operable to move along the length of a cart or basket 108 or a series of carts or baskets. The carts or baskets 108 may optionally be nested. The moving arm 120 may include one or more articulating joint operable to rotate the arm to face the cart or basket 108 from front and back sides to expose both sides of the carts to treatments described herein. Similarly the arm may include articulating joints operable to move the arm 120 upward and downward to address the entirety of the cart or basket 108 and/or provide diversification of treatment impingement angles.

Some or all of one or more ultraviolet light emitters, one or more steam nozzles, one or more spray jets, and/or one or more blower vents may be disposed on a moving arm 120 or elsewhere within a containment system 132. A sensor, such as a video camera may further be mounted on the moving arm and may be used to determine the state of the cart or basket, may be used to aid in determining automatic wash options, and/or may be used to determine when to end a wash phase.

At least one fluid source 118 may provide at least one of rinse water, wash water, pressurized water, steam, or antibacterial solution through the electronically-controlled valve 114 and pump 116 to the nozzle 104. A reclamation system 124 may receive and recycle the at least one fluid after application to the at least one cart or basket 108. The reclamation system 124 may include an overspray collector 126 such as a drain, a holding tank 128, and a filtration system 130 to remove impurities. The reclamation system 124 may further include a drain line (not shown) to purge impurities to a sewer connection (not shown).

A containment system 132 may be configured to substantially prevent overspray from the nozzle from reaching a user. The containment system 132 may include one or a combination of air curtains, flexible curtains, windows, walls, doors, etc. An exhaust system 134 such as a fan and ductwork may be provided to remove moisture from the area.

A control panel 136 may be operatively coupled to the controller 112 and configured to receive user input and electronic display information to the user. The controller 112 may receive input from and transmit output to the control panel 136 and may be responsive to the user input.

Other mechanisms may be included but not shown FIG. 1 in the interest of fostering understanding. For example, a forced air, ultrasonic, or “cart-shaker” drying mechanism may be provided to remove moisture from the surface of the cart or basket after liquid washing. One or more ultraviolet lights may be provided to provide an antibacterial polish, for example singly or during a drying step. A blower or vacuum may remove loose debris from the cart or basket surface prior to other washing steps.

The cart or basket washer 102 may be configured for operation inside or outside a retail establishment, for example. Additional security features may be provided to prevent tampering. For example, especially for applications where the cart or basket washer 102 is located outdoors, integrated security gates may be provided to reduce or prevent access to the machine during off hours.

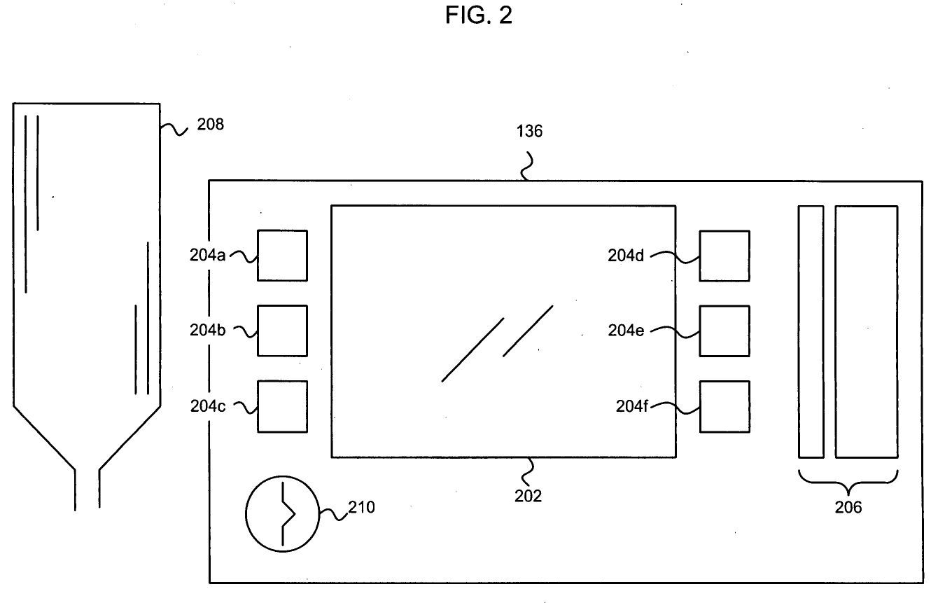

FIG. 2 is a diagram of an illustrative control panel 136 made according to an embodiment. The control panel 136 may include an electronic display 202 configured to display information such as options and/or instructions to a user. Context-sensitive buttons 204a-204f may be configured to receive user input. For example the electronic display 202 may present static instructions, dynamic instructions, washing options, washing status, and/or fault status.

The control panel 136 may be customized to contain more or fewer of the options described herein. Optionally, items may be combined into one button, or may be selectable using separate buttons. Buttons may be solid-state or may be mechanical.

According to an embodiment, the control panel may receive input or optionally sensor input may be used to determine wash options. For example, the behavior of the system may be modified for hot day operations, cold day operations, wet clean operations, and/or dry clean operations (e.g., dust-off plus UV).

The control panel 136 may further include a payment or registration device 206. For example, the payment or registration device 206 may include a magnetic stripe reader, a bar code reader, a radio frequency identification interrogator, a coin receiver, a token receiver, and/or a bank note receiver. The registration device 206 and/or a keypad (not shown) may be configured to receive a loyalty card number in lieu of payment.

A waterless hand sanitizing station 208 may be provided on or adjacent to the control panel 136. A key lock 210 or PIN input may provide an override or modification of functions. For example, a key lock may provide for override of the safety condition detection, with safety instead being realized according to training provided to the key-holder.

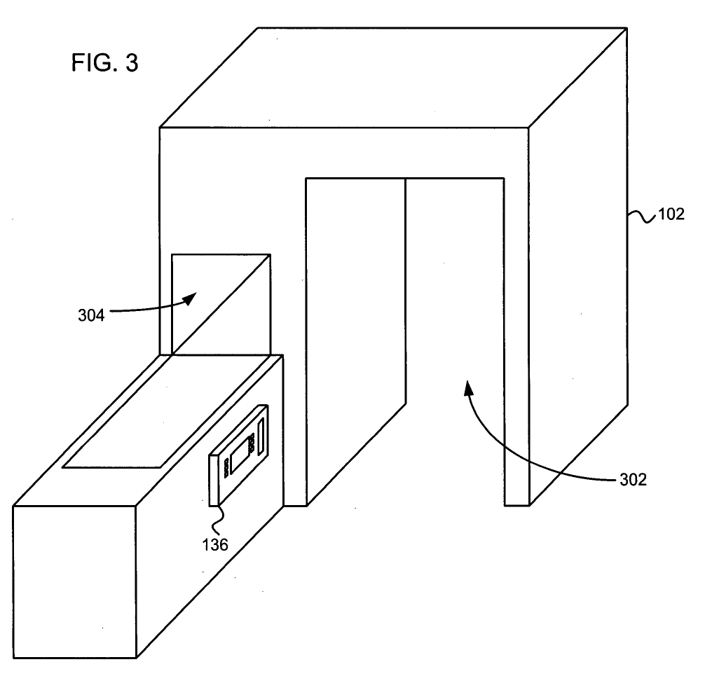

FIG. 3 is a depiction of a washer 102 that includes provisions for washing a shopping cart in a first volume 302 and a shopping basket in a second volume 304. A control panel 136 may be configured to receive commands to actuate cart washing functions and/or basket washing functions. The mechanism for washing the cart and/or basket may be shared or may include separate nozzles, blowers, etc.

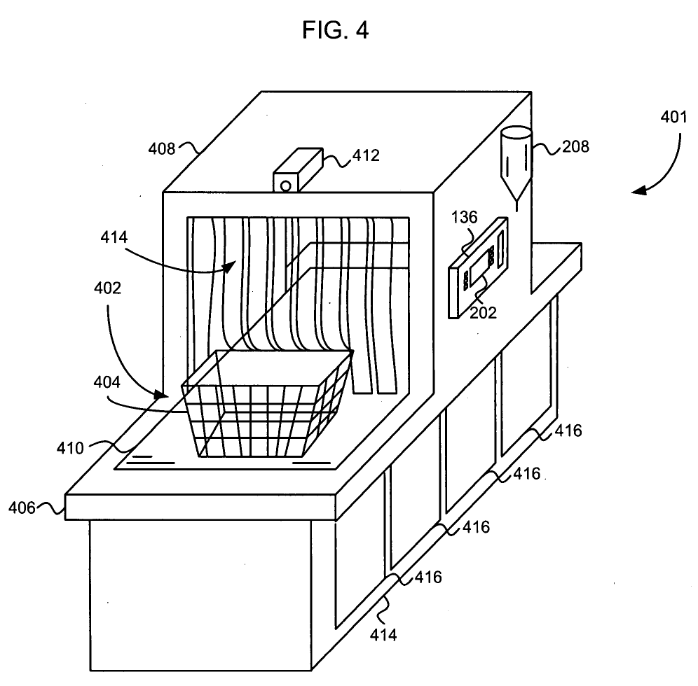

FIG. 4 is a depiction of a shopping basket washer 401, according to an embodiment. A shopping basket receiving station 402 may be sized and configured to receive a shopping basket 404. For example, the shopping basket receiving station 402 may be provided at a location elevated off the floor such as on a table 406 for convenient access by a shopper. A shopping basket washing mechanism (not shown) may be disposed within a containment vessel 408. A conveyer 410 may be provided to move the basket from the basket receiving station 402 into the containment vessel 408 for washing.

A sensor 412 may be operatively coupled to the controller (not shown) to sense a safety condition. For example, the sensor 412 may include a digital video camera aimed toward the entrance to the containment vessel 408. The controller may be operable to run image processing software configured to detect the presence or absence of a user's hand, etc. from the basket receiving zone 402. The controller may then actuate basket washing when the safety condition is met, or advise the shopper to move away from the dangerous position if the safety condition is not met. For example, the controller may advise the shopper via a message displayed on a video screen 202 of a control panel 136 or issue an audible warning through a speaker (not shown).

A fluidic mechanism (not shown) operatively coupled to the controller and the washing mechanism may be disposed in a cabinet 414 below the table 406 defining the elevated location for receiving the shopping basket 404. The fluidic mechanism, for example, may include a reclamation system 124, fluid tanks 118, one or more selector valves 114, and one or more pumps 116 as shown in FIG. 1. The cabinet 414 may include doors or drawers 416 positioned to allow fast and convenient replenishment of fluids and/or maintenance of the mechanisms therein.

As described above, a waterless hand cleaner 208 may be provided for convenient access by users. For example, the user may use the waterless hand cleaner 208 prior to picking up the newly-cleaned shopping basket.

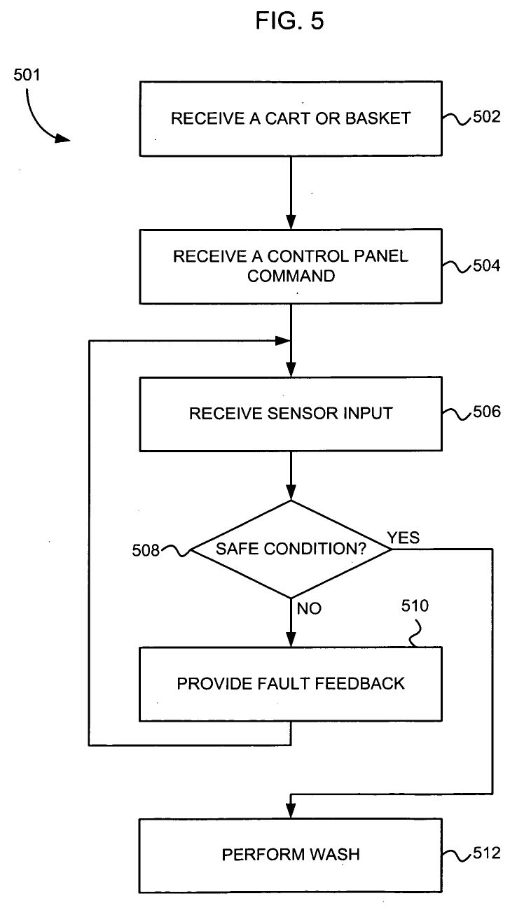

FIG. 5 is a flow chart illustrating a method 501 for washing a cart or basket, according to an embodiment. In step 502, a cart or shopping basket is received. A cart may include a shopping cart, a golf cart, or a baggage cart, for example. The cart or shopping basket may be singulated or nested, depending on the embodiment. For example, store personnel may present shopping baskets nested five deep at night, while customers present baskets one at a time during the day.

Receiving a cart may include receiving a cart at a stationary wash station, receiving a cart at a conveyer input station, or receiving a cart at a guidance track by manual force, for example. Receiving a shopping basket may include receiving a shopping basket at a stationary wash station, receiving a shopping basket at a conveyer input station, or receiving a shopping basket at a guidance track by manual force, for example.

Proceeding to step 504, a control panel command is received. For example, a single button press may be used to start a wash cycle. Alternatively, the control panel command may include selection from a number of wash options or wash treatments. For example, the user may select only an antibacterial rinse, or may select a full pressure wash plus an antibacterial rinse, plus an air dry with UV exposure.

Receiving a control panel command may include receiving a payment. The payment may be monetary or may include receiving a loyalty card identity without a transfer of funds. The amount of payment may be determined as a function of the wash level selected. Payment may be made when the shopper subsequently checks out, for example by scanning a bar code on the basket or cart, or by receiving a loyalty card number.

Alternatively, in some embodiments, the control panel input may include or consist of receipt of a presence sensor input indicating presence of a cart or basket at a receiving station.

Proceeding to steps 506 and 508, input is received from one or more safety sensors and a safety condition is determined by the controller, respectively. Taken together, steps 506 and 508 may constitute determining a safety condition. Nominally a safe condition corresponds to no person or part of a person being in an unsafe location.

Determining a safety condition may for example include receiving inputs from one or more safety sensors. For example, determining a safety condition 506, 508 may include analyzing at least one video image of an area at or near a washing mechanism, determining that at least one door is closed to separate a person from the washing mechanism, receiving a control activation at a location separated from the washing mechanism, verifying a state of a pressure switch, or verifying a light transmission path to an optical sensor. Other types of sensing mechanisms such as radar, sonar, capacitive, etc. may also be used singly or in combination.

If the safety condition is not met, the controller prevents operation of the cart or basket washer. Optionally, the process 501 may proceed to step 510, wherein feedback is provided to the user to indicate the unsafe condition. For example, feedback may be displayed on a control panel display screen or may include an audible warning.

If the safety condition is met, the process proceeds to step 512 wherein the cart or basket is washed. According to an embodiment, the controller may constantly monitor the safety sensor or sensors and stop the wash if a safety fault occurs. According to some embodiments, cart or basket position sensors may be used to augment the safety sensor, for example to determine excessive drag on the cart or basket, indicating incorrect insertion or potential entanglement with the user.

Performing the wash 512 may include conveying the cart or shopping basket through a plurality of wash stations. Additionally or alternatively, performing the wash 512 may include conveying a washer arm past a stationary cart or shopping basket.

As indicated above, performing a wash may include one or more of a range of treatments, according to various embodiments. For example, performing a wash function may include rinsing the cart or shopping basket, soaping the cart or shopping basket, pressure washing the cart or shopping basket, steam cleaning the cart or shopping basket, drying the cart or shopping basket, vacuuming the cart or shopping basket, blowing off the cart or shopping basket, heating the cart or shopping basket, shaking the cart or shopping basket, vibrating the cart or shopping basket with an ultrasonic transducer; providing an antibacterial rinse to the cart or shopping basket, and exposing the cart or shopping basket to ultraviolet light.

According to an embodiment, wash treatments may be offered to the user in tiered bundles. A basic wash may include an antibacterial rinse. A medium grade wash may include an antibacterial rinse followed by hot air drying while simultaneously illuminating the cart or basket with ultraviolet light. A premium wash may include pressure washing, followed by an antibacterial rinse, followed by hot air drying while simultaneously illuminating the cart or basket with ultraviolet light.

According to an embodiment, the cart or basket washer may include one or more sensors to determine the condition of the cart or basket, for example by determining the degree of soiling. One approach to sensing the condition may include performing image analysis on an image of the cart or basket. For example, biological molecules (which may correspond to bacteria) may tend to auto-fluoresce upon exposure to infrared illumination. The controller may invoke an additional washing step or extended washing time upon detecting excessive auto-fluorescence on the surface of the cart or basket.

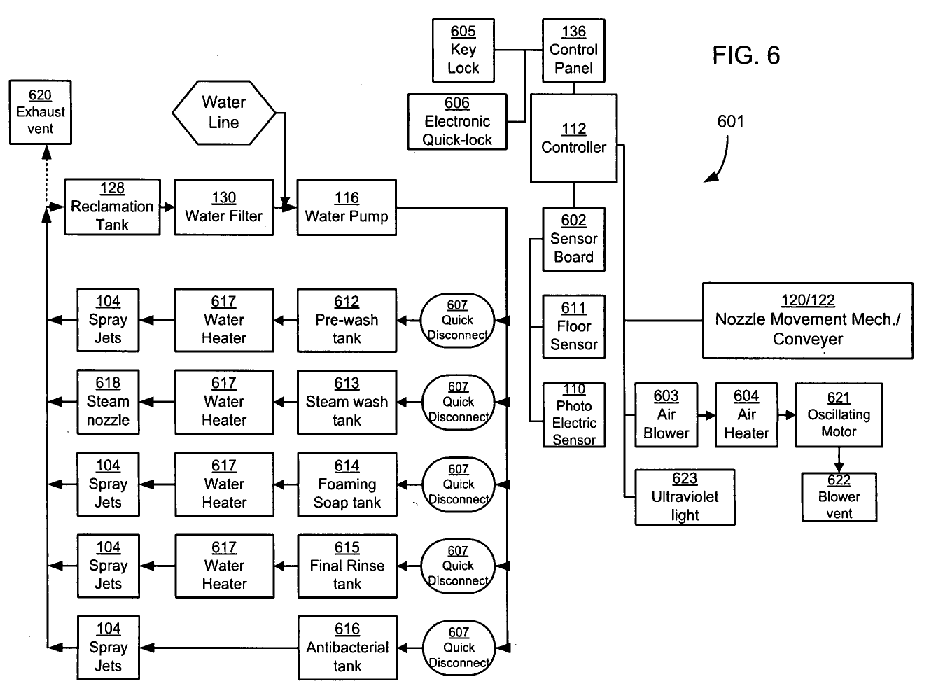

FIG. 6 is a block diagram that shows relationships between functional blocks, according to an embodiment. The washer 601 includes a controller 112. A control panel 136 interfaces to the controller 112. The control panel 136 may include user input and/or outputs. For clarity, electronic connections between the controller 112 and fluidic components are omitted. It will be understood that fluidic components may be provided with actuation control, level sensors, flow sensors, temperature sensors, and the like that interface to the controller 112 via interfaces that are not shown.

The controller 112 may contain programmable options, preprogrammed cleaning settings, water shut offs, a sensor board 602, a key lockout 605, and electronic lockout 606. For example, on a rainy day the operator may choose to turn off the pressure washer and leave on the conveyer feature and hot air blowers to dry one or more carts or baskets before entering a store. The controller 112 may include a setting for air-drying functions, for example, a heated or unheated blower. The washer 601 may include an enclosed steam washing area that sanitizes carts or baskets. The controller 112 may include a variable speed control for conveyer feed to allow carts or baskets to proceed through wash faster or slower.

The shopping cart or basket conveyer or nozzle movement mechanism 120/122 may feed shopping carts or baskets through the washer or the washing unit around carts or baskets. The shopping cart or basket conveyer or nozzle movement mechanism 120/122 may use octagonal or hexagonal stainless steel metal rods that fit in to octagonal or hexagonal metal sockets for easy installation and removal. The shopping cart or basket conveyer or nozzle movement mechanism 120/122 may use a track-in-floor system to push cart wheels through the washer.

The sensor board 602 may be located in the controller 112 or control panel 136. The sensor board 602 may interface to various sensor systems, and may for example provide advanced sensing functions such as image processing. The controller 112 may control the shopping cart or basket conveyer or nozzle movement mechanism 120/122 and other portions of the washer 601 that may cause injury responsive to input from the sensor board 602.

An air blower 603 may dry shopping carts or baskets after washing or after a rainstorm. The air blower 603 may include settings for non-heated functions. For example, mass air flow may be varied according to heating or non-heating of the air.

An air heater 604 may heat blower air. For example, the air heater 604 may provide heating or additional heating on cold days to aid in faster drying or blowing off dust.

The key lock 605 may include mechanical locks or keypad lock to lockout all functions when operator is not attending washer/sanitizer. The key lock 605 may incorporate a key operation or keypad lock to disable the electric heated air blowers, the water pump 116, the shopping cart or basket conveyer or nozzle movement mechanism 120/122, and/or other portions of the washer 601 from operating. Subsystems may be run independently. The pressure plate sensor 611, photoelectric sensor 110, and safety logic may optionally disabled during testing and calibration and may be enabled when the washer is in operation.

An electrical quick lock 606 may immediately lock up all functions and may be unlocked by key or combination code.

One or more quick disconnects for water 607 may allow operator to quickly disconnect water from washer when shipping cart washer needs to be stored or maintained. Additional quick disconnect fittings 607 may be included to allow rapid disconnection of other fluid lines. According to an alternative embodiment, one or more of the quick disconnect fittings 607 may be combined into one line instead of separate lines.

A photoelectric sensor 110 may be used as a safety sensor. Alternatively, one or more photoelectric sensors 110 may also be used to sense position and/or movement of carts or baskets through the washer. Safety logic may determine if a person is crossing the sensor axis or if a line of carts is being passed through the sensor axis. For example, a periodic breaking of the beam by cart wheels may be differentiated from a human by measuring the difference in timing, duration, etc.

A water filter 130 may be used to filter dirt, soap, or other debris that could clog machine or spray jets and nozzles. A water pump 116 may be used to deliver water from reclamation tank 128 and/or from an input water line to washing stations.

A floor sensor (Pressure plate) 611 may be placed in front of the cart or basket washer to make sure a child or animal is not trying to walk through the washer. The controller 112 may enable an audible and/or visual alarm when a child or animal is sensed by the floor sensor 611.

A pre-wash tank 612 may include a sanitizing, antibacterial solution, or soap solution for mixing water and sanitizing agent. A steam wash tank 613 may include a sanitizing, antibacterial solution, or a soap solution for mixing water and sanitizer. A foaming soap tank 614 may hold soap solution or sanitizer to be mixed with water or other sanitizing solution. A final rinse tank 615 may include a rinsing agent or sanitizer to be sprayed on a cart or basket before drying. An antibacterial tank 616 may contain an antibacterial agent used to kill bacteria, spores, etc. on the surface of carts or baskets. Water heaters 617 may be used to bring water to a desired temperature.

One or more steam nozzles 618 may be used to deliver a fine mist of hot water or other solution instead of a harsh jet of water. Alternatively, the one or more steam nozzles 618 may be used to deliver steam to the cart or basket.

Spray jets 104 may direct the respective solutions onto the inside and/or outside surfaces of a shopping cart or basket. As indicated above, spray jets 104 may be held substantially stationary, with a cart or basket being conveyed past. Alternatively, spray jets 104 may be mounted on a moveable support such as a robotic arm and the arm moved past a substantially stationary cart or basket.

A reclamation tank 128 may be used to reclaim water to reduce the waste of water and aid in store owner's conservation of water. According to alternative embodiments, an outdoor reclamation tank or cistern may be used for rain water storage. The cistern may allow rain water to be stored for use in washer to save on water usage and expense, and may also aid in conservation.

An exhaust vent 620 may be used to prevent the build up of moisture inside washing unit, thus aiding in the reduction or elimination of the growth of bacteria.

Returning to the air delivery system, an oscillating motor 621 may be used to move blower vents 622 over shopping carts or baskets to ensure substantially all areas of shopping carts have airflow over them. The blower vents 622 may be used to direct airflow in order to cover a wider surface area of shopping cart to ensure carts are substantially dried before entering use. One or more ultraviolet lights 623 may be used to kill light sensitive bacteria and provide an extra sense of safety to a user. According to an embodiment, ultraviolet lights are applied during drying and an indication of ultraviolet application is made on the control panel display.

Mounting hardware (not shown), enclosures, etc. may take many forms. For example, the washer may be surface mounted to existing railing using quick release straps.

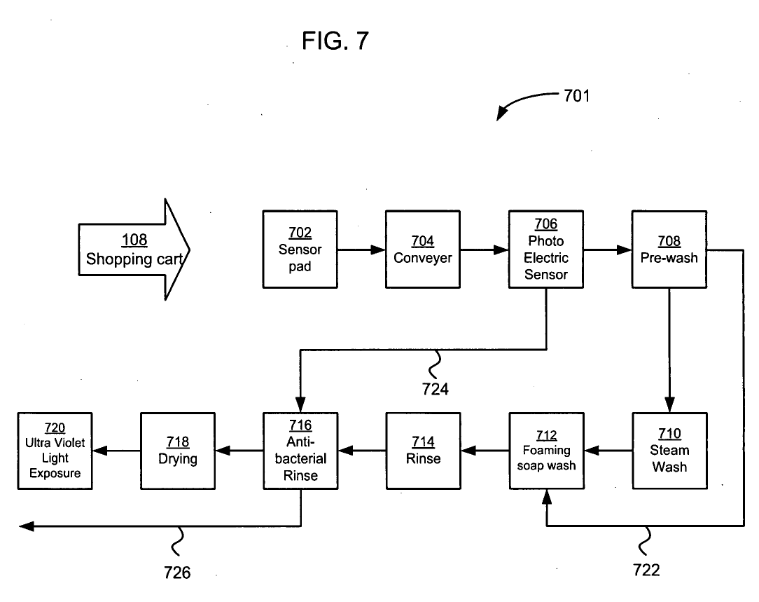

Referring now to FIG. 7, a cart washing progression 701 is conceptually illustrated as a block diagram of optional components. In one embodiment, one or more carts or baskets may be transported past substantially non-moving treatment stations. In another embodiment, one or more moving treatment stations may be transported past substantially non-moving carts.

A cart or basket 108 is received at an optional pressure sensor pad 702. The pressure sensor pad 702 may be used to verify a weight range and verify positioning of the cart or basket. The cart or basket may then be conveyed by a conveyer 704 to one or more wash stations. A photo-electric sensor 706 may provide additional safety sensing to verify isolation of the cart or basket from the user.

According to an option embodiment, the cart or basket may then enter a prewash 708. During prewash 708, one or more nozzles may spray water having a temperature of about or above 120° F. The water may include a sanitizing or antibacterial solution, or soap solution. The prewash solution may flow from one hose or a series of hoses.

The cart or basket may then proceed to a steam wash 710. Steam wash 710 may literally include exposing the cart or basket surfaces to saturated or superheated steam, or may alternatively include a pressure wash by a high pressure nozzle.

The cart or basket may then proceed to a foaming soap wash 712. During the foaming soap wash 712, a foaming soap solution may be sprayed over the cart or basket. The foaming soap solution may flow from one hose or a series of hoses. The foaming soap solution may flow through dedicated connections and auxiliary apparatuses, or may use combined apparatuses, fluid lines, etc. The cart or basket may be allowed to soak with foaming soap for several seconds after application. Various detergent or solvent solutions may be used for the foaming soap wash. According to embodiments, especially embodiments where the cart or basket may be visible to the user, a solution is selected to maintain soap bubbles on the surface for at least several seconds after application or until rinsing.

The cart or basket may then enter a rinse 714. The rinse 714 may include a water rinse, and/or may include additional surfactants to aid in water flow and reduce spotting. The rinse 714 also may use connections and auxiliary apparatuses similar to the other phases and/or may use combined apparatuses, fluid lines, etc.

The cart or basket may then enter an antibacterial rinse 716. The antibacterial rinse 716 may include an antibacterial solution. The antibacterial phase also may use connections and auxiliary apparatuses similar to the other phases and/or may use combined apparatuses, fluid lines, etc. Suitable antibacterial rinses may include acetic acid, 2% citric acid, 20% potassium monopersulfate, sulphamic acid, or other food-safe sanitizing agents.

The cart or basket may then enter drying 718. Drying 718 may be provided by an air heater such as an electronic air heater and/or a blower, by mechanically shaking the cart, and/or by an ultrasonic dryer. The drying phase may be used, for example, on cold days to aid in faster drying, or may typically be used, especially in cases where carts are to be used soon after washing. Alternatively, the drying phase may be used alone for heating cold carts. Alternatively, the drying phase may be used alone or in combination with other phases for blowing off dust.

After or at the same time as drying 718, the cart or basket may enter ultraviolet (UV) light exposure 720. To make UV exposure apparent to the user, UV light may be combined with blue or violet light, and/or application may be noted on a video display.

Some washing steps may be abbreviated or skipped according to user preference. For example, the series of wash steps described above may constitute a “premium” wash option, which may for instance be available for extra cost, higher loyalty points, etc. A “standard” wash option may skip the “steam” cleaning step 710, as indicated by connector 722. A “quick” wash option may follow connector 724 and or 726, which in combination provide just an antibacterial rinse. The “quick” wash may be especially suitable for on-the-go customers and/or for use during times of peak use, for example.

The preceding overview, brief description of the drawings, and detailed description describe exemplary embodiments according to the present invention in a manner intended to foster ease of understanding by the reader. Other structures, methods, and equivalents may be within the scope of the invention. For example, methods and physical embodiments may be combined or used singly.

While the term “wash” and its derivatives are used for ease of understanding, it shall be understood that such terminology may refer to a range of treatments including, but not limited to, rinsing, soaping, steam cleaning, drying, vacuuming, blowing off, heating, applying an antibacterial rinse, and exposure to ultraviolet light. While the term “payment” and its derivatives are used for ease of understanding, it shall be understood that such terminology is not necessarily limited to monetary consideration. For example, cart washing services may be provided free-of-charge by a retailer to loyalty-card holders (and optionally, for payment by non-loyalty card holders). In such case, “payment” may involve presentation of loyalty card identification rather than an exchange of tangible value. While a “control panel” may include a conventional panel with buttons and/or switches, it may alternatively comprise a sensor to determine positioning of a cart, and optionally, a payment receiving apparatus.

As such, the scope of the inventions described herein shall be limited only by the claims.

What is claimed is:

1. A method for washing a cart or shopping basket comprising:
receiving a cart or shopping basket;
receiving a control panel command;
determining a safety condition; and
performing a wash function corresponding to the control panel command while the safety condition is met.

2. The method of claim 1, wherein receiving a control panel command includes receiving a payment.

3. The method of claim 2, wherein receiving the payment includes receiving a loyalty card identity without a transfer of funds.

4. The method of claim 1, wherein performing a wash function includes conveying the cart or shopping basket through a plurality of wash stations.

5. The method of claim 1, wherein performing a wash function includes conveying a washer arm past a stationary cart or shopping basket.

6. The method of claim 1, wherein receiving a control panel command includes receiving a selection of one or more wash treatments; and
wherein performing a wash function includes performing the selected one or more wash treatments.

7. The method of claim 1, further comprising:
determining a condition of the cart or shopping basket; and
wherein performing the wash function further includes selecting one or more of a plurality of wash treatments responsive to the condition of the cart or shopping basket.

8. The method of claim 1, wherein performing a wash function includes performing at least one selected from the group consisting of: rinsing the cart or shopping basket, soaping the cart or shopping basket, pressure washing the cart or shopping basket, steam cleaning the cart or shopping basket, drying the cart or shopping basket, vacuuming the cart or shopping basket, blowing off the cart or shopping basket, heating the cart or shopping basket, shaking the cart or shopping basket, vibrating the cart or shopping basket with an ultrasonic transducer; providing an antibacterial rinse to the cart or shopping basket, and exposing the cart or shopping basket to ultraviolet light.

9. The method of claim 1, wherein receiving a cart or shopping basket includes receiving a cart at a stationary wash station, receiving a cart at a conveyer input station, receiving a cart at a guidance track by manual force, receiving a shopping cart, receiving a golf cart, receiving a baggage cart, receiving nested carts, receiving a shopping basket at a stationary wash station, receiving a shopping basket at a conveyer input station, receiving a shopping basket at a guidance track by manual force, receiving a singulated shopping basket, and receiving stacked shopping baskets.

10. The method of claim 1, wherein determining a safety condition includes receiving a response from one or more sensors, the response being indicative that no person or part of a person is in an unsafe location.

11. The method of claim 10, wherein determining a safety condition includes at least one of analyzing at least one video image of an area at or near a washing mechanism, determining that at least one door is closed to separate a person from the washing mechanism, receiving a control activation at a location separated from the washing mechanism, verifying a state of a pressure switch, verifying a light transmission path to an optical sensor, receiving a radar input, receiving a sonar input, or receiving a capacitive sensor input.

12. A cart washer, comprising:
at least one nozzle configured to spray at least one cleaning fluid to wash at least one cart substantially without intervention of a user;
at least one sensor configured to sense a condition corresponding to safety of the user; and
a controller operatively coupled to the at least one nozzle and the at least one sensor, the controller being configured to determine the condition corresponding to safety of the user and conditionally actuate the nozzle and drive at least one of movement of the at least one cart or movement of the at least one nozzle when the safety condition is met.

13. The cart washer of claim 12, further comprising:
a cart conveyer configured to move the at least one cart;
and wherein the controller is configured to conditionally drive the movement of the at least one cart past the at least one nozzle.

14. The cart washer of claim 12, further comprising:
a moveable arm configured to move the at least one nozzle past the at least one cart;
and wherein the controller is configured to conditionally drive the movement of the at least one nozzle past the at least one cart.

15. The cart washer of claim 12, further comprising:
at least one fluid source configured to provide at least one of rinse water, wash water, pressurized water, steam, antibacterial solution, air, or vacuum;
at least one electronically-controlled valve operatively coupled to the controller and configured to selectively deliver at least on fluid from the at least one fluid source to the at least one nozzle; and
a reclamation system configured to receive and recycle the at least one fluid after application to the at least one cart.

16. The cart washer of claim 12, further comprising:
a containment system configured to substantially prevent overspray from the nozzle from reaching the user.

17. The cart washer of claim 12, further comprising:
a control panel operatively coupled to the controller, configured to receive user input and electronic display information to the user; and
wherein the controller is responsive to the user input.

18. The cart washer of claim 17, wherein the user input includes at least one of washing options, payment, or loyalty card input;
and wherein information displayed to the user includes at least one of static instructions, dynamically displayed instructions, washing options, and washing status.

19. The cart washer of claim 17, further configured to wash a shopping basket;
and wherein the control panel is configured to receive commands to wash the shopping basket.

20. The cart washer of claim 17, further comprising:
a waterless hand sanitizing station arranged in proximity to the control panel for convenient access by the user.

21. The cart washer of claim 12, further comprising:
a washing station configured to receive a shopping basket in addition to or in lieu of a cart;
and wherein the at least one nozzle, at least one sensor, and controller are further configured to cooperate to wash the shopping basket.

22. The cart washer of claim 12, further comprising:
at least one nozzle configured to wash a shopping basket.

23. A shopping basket washer, comprising:
a shopping basket receiving station sized and configured to receive a shopping basket at an elevated location; and
a shopping basket washing mechanism configured to wash the shopping basket.

24. The shopping basket washer of claim 23, further comprising:
at least one sensor configured to determine that a user is not in a dangerous position; and
a controller operatively coupled to the sensor and the shopping basket washing mechanism configured to actuate the shopping basket washing mechanism conditional to a signal from the sensor.

25. The shopping basket washer of claim 24, further comprising:
a fluidic mechanism operatively coupled to the controller and the washing mechanism disposed in a cabinet below the elevated location and configured to deliver at least one fluid to the washing mechanism.
